(19) United States
(12) Patent Application Publication
(10) Pub. No.: US 2026/0059392 A1
(43) Pub. Date: Feb. 26, 2026

(54) MEDIA SESSION TRANSFER FOR UNAVAILABLE APPLICATIONS

(71) Applicant: Motorola Mobility LLC, Chicago, IL (US)

(72) Inventors: Amit Kumar Agrawal, Bangalore (IN); Ranjeet Gupta, Bengaluru (IN); Vishwanath KM, Bengaluru (IN)

(73) Assignee: Motorola Mobility LLC, Chicago, IL (US)

(21) Appl. No.: 18/813,262

(22) Filed: Aug. 23, 2024

(51) Int. Cl. H04W 36/00; H04W 36/32; H04W 36/36

(52) U.S. Cl. CPC H04W 36/0011; H04W 36/00698; H04W 36/32; H04W 36/365

(57) ABSTRACT

In aspects of media session transfer for unavailable applications, a mobile device receives, from a computing device, a transfer indication that a media session active on the computing device is to be transferred to the mobile device. The media session is associated with a media application that is unavailable on the mobile device. The mobile device establishes a communication link with the computing device and receives, via the communication link, the transfer of the media session. The media session is continued on the mobile device. In implementations, the computing device detects that a user of the computing device is moving away from the computing device while the media session is active on the computing device, for example, by detecting that the mobile device is moving away from the computing device and performing channel sounding with the mobile device.

### BACKGROUND

Today's person is afforded a tremendous selection of devices that are capable of performing a multitude of tasks. For instance, desktop and laptop computers provide computing power and screen space for productivity and entertainment tasks. Further, smartphones and tablets provide computing power and communication capabilities in highly portable form factors. Many people have access to multiple different devices and use of a particular device depends on the person's current status, such as on the go, in the office, at home, and so forth. While individual instances of devices provide functionality for discrete sets of tasks, the ability for devices to intercommunicate with one another greatly expands available task options and operating environments. For instance, a typical smartphone is able to wirelessly cast visual content to a larger screen device to enable enhanced enjoyment of the content. While the ability for devices to intercommunicate provides for numerous usage scenarios, challenges may arise when different devices are unable to support the same applications.

### BRIEF DESCRIPTION OF THE DRAWINGS

Implementations of the techniques for media session transfer for unavailable applications are described with reference to the following Figures. The same numbers may be used throughout to reference like features and components shown in the Figures.

FIGS. 1 and 2 illustrate example systems for media session transfer for unavailable applications in accordance with one or more implementations as described herein.

FIG. 3 further illustrates an example system and procedure for media session transfer for unavailable applications in accordance with one or more implementations as described herein.

FIGS. 4-6 illustrate example methods for media session transfer for unavailable applications in accordance with one or more implementations of the techniques described herein.

FIG. 7 illustrates various components of an example device that may be used to implement the techniques for media session transfer for unavailable applications as described herein.

### DETAILED DESCRIPTION

Techniques for media session transfer for unavailable applications may be implemented as described herein to provide relatively seamless transfer of an active media session of a media application from a first device to a second device, even when the second device does not support the media application. Generally, the described implementations utilize sensor data and channel sounding (e.g., Bluetooth (BT) channel sounding) to determine whether a user of the first device is moving away from the first device and, if so, to transfer the media session to the second device. Thus, the user may continue the media session on the second device without interruption.

For example, a person may attend a virtual meeting event from a relatively stationary computing device, such as a laptop or desktop computer. As remote work has become increasingly common, many employees working remotely may spend a large portion of their day and/or workweek attending video conferences, live webinars, virtual training sessions, or the like. Using a laptop or desktop computer for such virtual meetings may be more convenient than using a mobile device (e.g., a tablet or mobile phone), for instance, to utilize a larger screen or to access work related content or servers that are unavailable on other devices. However, if the person wishes to move away from the computing device during a virtual meeting, he or she may miss important information or may inconvenience other attendees. Moreover, conventional techniques for sharing content between devices are generally limited to casting from a mobile device to a stationary device with a larger display (e.g., a laptop, desktop computer, television, or the like), or casting from an application instance on a first device to an instance of the same application on the second device.

As such, conventional techniques may not support transfer of the virtual meeting from a stationary device to a relatively more mobile device, particularly when the media application running the virtual meeting is not available on the mobile device (e.g., such that sharing across application instances is not possible). For example, the mobile device may not support the media application, due to the media application may be configured for a different operating system than that of the mobile device, the mobile device may have limited capabilities for the media application, or the media application may not be installed on the mobile device. Further, the media application may require a virtual private network (VPN) that is only available on the computing device, or the media application may not be authenticated at the mobile device.

Accordingly, the techniques described herein enable a seamless transfer of a media session (e.g., a video conference, a virtual meeting, video playback, audio playback, etc.) from a computing device to a mobile device when a media application associated with the media session is unavailable on the mobile device. Continuing the aforementioned example, the user attending the virtual meeting at the computing device may wish to take a quick break, make a cup of coffee, answer the doorbell, or the like. The mobile device may be in physical proximity to the user, and the mobile device and the computing device may be configured for direct communication via wireless connectivity (e.g., a communication link, such as BT, ultra-wideband (UWB), Wi-Fi, millimeter wave (mmW), Zigbee, free space optical (FSO), long range (LoRa), or the like, among other examples). The computing device and the mobile device can monitor sensor data and/or perform channel sounding to determine that the user has moved away from the computing device, and may initiate transfer of the virtual meeting to the mobile device via the communication link. For example, the computing device can communicate (e.g., transfer, route) meeting content (e.g., audio and/or video) to the mobile device for output at the mobile device. The user may therefore move about and away from the computing device while attending the virtual meeting from the mobile device.

Additionally, in some examples, the computing device and/or the mobile device may detect (e.g., based on the sensor data and/or the channel sounding) that the user has returned to the computing device (e.g., is within close physical proximity to the computing device), and may initiate transfer of the virtual meeting back to the computing device. In some cases, transfers of the media session between devices may be automatically initiated according to the user's location. As an example, the computing device can automatically transfer the virtual meeting to the mobile device based on detecting that the user of the computing device has moved away from the computing device, and can automatically transfer the virtual meeting back to the computing device when the user returns to the computing device. Alternatively, the mobile device may prompt the user to accept or deny the transfer. In some cases, the user may select whether to transfer audio, video, or both to the mobile device.

The described techniques thus enable seamless device-based content sharing without the need for the shared or transferred application to be present on both devices. The user may freely leave and return to the computing device without disrupting the media session, thereby providing an improved user experience. Additionally, the media session may be displayed on the mobile device even when the corresponding application is not supported by, or available on, the mobile device, thus alleviating hassle caused by incompatibility between devices. In implementations, the computing device may select a high data throughput (HDT) transport method, such as BT HDT, for sharing content with the mobile device, which may improve communication efficiency and throughput, as well as reduce latency.

While features and concepts of the described techniques for media session transfer for unavailable applications is implemented in any number of different devices, systems, environments, and/or configurations, implementations of the techniques for media session transfer for unavailable applications are described in the context of the following example devices, systems, and methods.

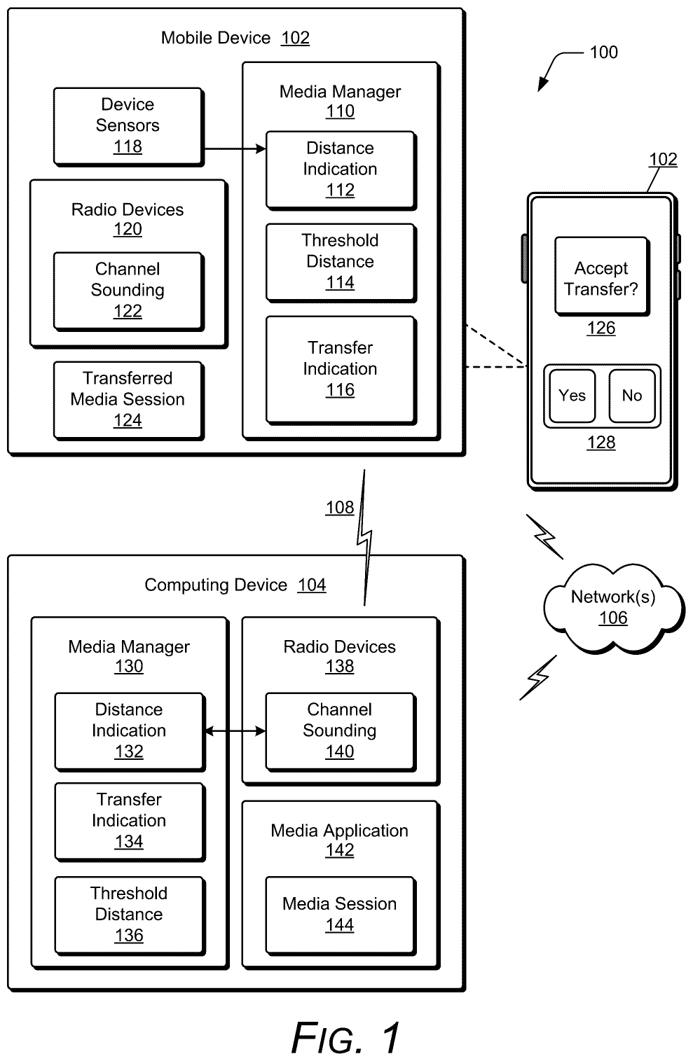

FIG. 1 illustrates an example environment 100 for media session transfer for unavailable applications, as described herein. The environment 100 includes a mobile device 102, a computing device 104, and a communication network 106. Examples of mobile devices include at least one of any type of a wireless device, mobile device, mobile phone, flip phone, client device, companion device, tablet, computing device, communication device, entertainment device, gaming device, media playback device, any other type of computing, consumer, and/or electronic device. In this particular example, the mobile device 102 represents a portable device that can be carried by a user, such as a smartphone, a tablet device, a wearable device, or the like. These examples are not to be construed as limiting, however, and the mobile device 102 and/or the computing device 104 can be implemented in a variety of different ways and form factors.

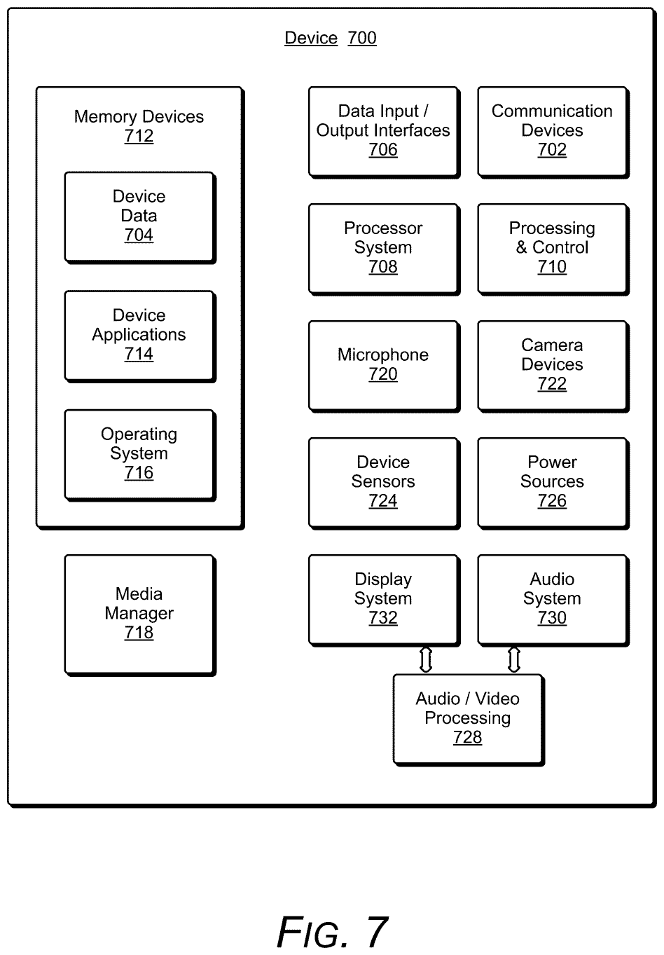

The mobile device 102 can be implemented with various components, such as a processor system and memory, as well as any number and combination of different components as further described with reference to the example device shown in FIG. 7. Further, the mobile device 102 includes various functionality that enables the mobile device 102 to perform different aspects of media session transfer for unavailable applications discussed herein, including a media manager 108, device sensors 110, and radio devices 112 media session 114. As discussed in further detail below, the media manager 108 is representative of functionality that enables the mobile device 102 to transfer a media session 122 to and from the computing device 104.

The device sensors 110 are representative of functionality to detect various physical and/or logical environmental features in relation to the mobile device 102, such as motion, light, image detection and recognition, time and date, position, location, touch detection, sound, temperature, and so forth. Examples of the device sensors 110 include hardware and/or logical sensors such as an accelerometer, a gyroscope, a camera, a microphone, a clock, biometric sensors, touch input sensors, position sensors, environmental sensors (e.g., for temperature, pressure, humidity, and so on), proximity sensors, geographical location information sensors (e.g., Global Positioning System (GPS) functionality), and so forth.

This example environment 100 includes a computing device 104, such as a laptop, desktop computer, or any type of device with computing functionality as described herein. Similar to the mobile device 102, the computing device 104 is implemented with various components, such as a processor system and memory, as well as any number and combination of the different components as further described with reference to the example device shown in FIG. 7. Further, the computing device 104 includes various functionality that enables the computing device 104 to perform different aspects of media session transfer for unavailable applications discussed herein, including a session manager 116, radio devices 118, and a media application 120. As discussed below, the session manager 116 is representative of functionality that enables the computing device 104 to transfer media sessions to and from the mobile device 102.

The media application 120 represents any type of media application, such as a virtual meeting application, a video communication application, a messaging application, a social media application, or any kind of application providing audio and/or video for a media session 122 on the computing device 104. In the examples described herein, the media application 120 may be an application that is unavailable on the mobile device 102. For example, the media application 120 may be incapable of running on the mobile device 102 and/or may be absent from the mobile device 102. Alternatively, the media application 120 may be present on the mobile device 102, but a media session 122 that is active by the media application 120 on the computing device 104 may be unavailable on the mobile device 102. For instance, the media application 120 may be unauthenticated at the mobile device 102, may be restricted by a VPN that is inoperable on the mobile device 102, or may have restricted functionality or capability on the mobile device 102.

In implementations, the mobile device 102 and the computing device 104 include various radios, such as the radio devices 112 and the radio devices 118, respectively, for wireless communication with other devices. For example, the radio devices 112 and the radio devices 118 can include a BT and/or Bluetooth Low Energy (BLE) transceiver, a UWB radio, and a near field communication (NFC) transceiver. In some cases, the radio devices 112 and the radio devices 118 include at least one of a Wi-Fi radio, a cellular radio, a global positioning satellite (GPS) radio, or any available type of device communication interface. The radio devices 112 and the radio devices 118 enable the mobile device 102 and the computing device 104 to perform channel sounding 124 and channel sounding 126, respectively. For instance, the channel sounding 124 and the channel sounding 126 may each include or be examples of BT channel sounding, UWB channel sounding, or the like, among other examples.

In some implementations, the devices, applications, modules, servers, and/or services described herein communicate via the communication network 106, such as for data communication with the mobile device 102 and the computing device 104. The communication network 106 can include a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 can include mobile operator networks that are managed by a mobile network operator and/or other network operators, such as a communication service provider, mobile phone provider, and/or Internet service provider.

In one or more examples, an interface module represents functionality (e.g., logic and/or hardware) enabling the mobile device 102 to interconnect and interface with other devices and/or networks, such as the computing device 104 via the communication network 106. For example, an interface module enables wireless and/or wired connectivity of the mobile device 102 and the computing device 104. In implementations, the mobile device 102 is communicatively linked to the computing device 104. For example, the mobile device 102 and the computing device 104 are communicatively linked via the communication network 106 and/or via direct inter-device connectivity between the mobile device 102 and the computing device 104, such as a communication link 128. In the latter example, the communication link 128 enables direct communication (e.g., device-to-device (D2D) communication) between the mobile device 102 and the computing device 104 (e.g., without the use of the communication network 106). For instance, the communication link 128 may include or be an example of a Bluetooth communication link, a UWB communication link, a mmW communication link, a Zigbee communication link, a LoRa communication link, an FOS communication link, or a Wi-Fi communication link, among other examples.

The mobile device 102 and the computing device 104 can include and implement various device applications, such as any type of media application 120, messaging application, email application, video communication application, cellular communication application, music/audio application, gaming application, social platform applications, and/or any other of the many possible types of various device applications. Many of the device applications have an associated application user interface that is generated and displayed for user interaction and viewing, such as on a display screen or display device of the mobile device 102 and/or the computing device 104. Generally, an application user interface, or any other type of video, image, graphic, and the like is digital image content that is displayable on the display screen or display device of the mobile device 102 and/or the computing device 104.

In the example environment 100 for media session transfer for unavailable applications, the mobile device 102 implements the media manager 108 (e.g., as a device application). As shown in this example, the media manager 108 represents functionality (e.g., logic, software, and/or hardware) enabling aspects of the described techniques for media session transfer for unavailable applications. The media manager 108 can be implemented as computer instructions stored on computer-readable storage media and can be executed by a processor system of the mobile device 102. Alternatively, or in addition, the media manager 108 can be implemented at least partially in hardware of the mobile device 102.

In one or more implementations, the media manager 108 includes independent processing, memory, and/or logic components functioning as a computing and/or electronic device integrated with the mobile device 102. Alternatively, or in addition, the media manager 108 can be implemented in software, in hardware, or as a combination of software and hardware components. In this example, the media manager 108 is implemented as a software application or module, such as executable software instructions (e.g., computer-executable instructions) that are executable with a processor system of the mobile device 102 to implement the techniques and features described herein. As a software application or module, the media manager 108 can be stored on computer-readable storage memory (e.g., memory of a device), or in any other suitable memory device or electronic data storage implemented with the controller. Alternatively or in addition, the media manager 108 is implemented in firmware and/or at least partially in computer hardware. For example, at least part of the media manager 108 is executable by a computer processor, and/or at least part of the content manager is implemented in logic circuitry.

In the example environment 100 for media session transfer for unavailable applications, the computing device 104 implements a session manager 116 (e.g., as a device application). As shown in this example, the session manager 116 represents functionality (e.g., logic, software, and/or hardware) enabling aspects of the described techniques for media session transfer for unavailable applications. The session manager 116 can be implemented as computer instructions stored on computer-readable storage media and can be executed by a processor system of the computing device 104. Alternatively, or in addition, the session manager 116 can be implemented at least partially in hardware of the computing device 104.

In one or more implementations, the session manager 116 includes independent processing, memory, and/or logic components functioning as a computing and/or electronic device integrated with the computing device 104. Alternatively, or in addition, the session manager 116 can be implemented in software, in hardware, or as a combination of software and hardware components. In this example, the session manager 116 is implemented as a software application or module, such as executable software instructions (e.g., computer-executable instructions) that are executable with a processor system of the computing device 104 to implement the techniques and features described herein. As a software application or module, the session manager 116 can be stored on computer-readable storage memory (e.g., memory of a device), or in any other suitable memory device or electronic data storage implemented with the controller. Alternatively or in addition, the session manager 116 is implemented in firmware and/or at least partially in computer hardware. For example, at least part of the session manager 116 is executable by a computer processor, and/or at least part of the content manager is implemented in logic circuitry.

In this example environment 100, the computing device 104 is running an active media session 122, such as an active video call, conference call, audio call, webinar, presentation, etc. by the media application 120. The mobile device 102 and/or the computing device 104 may detect that a user of the computing device 104 is moving out of physical proximity to the computing device 104. For instance, the device sensors 110 may detect position or location information for the mobile device 102 and/or the computing device 104, and the media manager 108 of the mobile device 102 and/or the session manager 116 of the computing device 104 may determine that a distance between the mobile device 102 and the computing device 104 is increasing. Additionally, or alternatively, the radio devices 112 of the mobile device 102 may perform the channel sounding 124, 126 with the radio devices 118 of the computing device 104 to obtain ranging data (e.g., BT ranging data, UWB ranging data) indicative of the distance between the mobile device 102 and the computing device 104.

Based on sensor data from the device sensors 110 and/or ranging data from the radio devices 112, the media manager 108 can determine that the distance satisfies (e.g., is greater than or equal to) a threshold distance 130, which may trigger transfer of the media session 122 from the computing device 104 to the mobile device 102. In some cases, the media manager 108 may transmit a distance indication 132 to the computing device 104 to inform the computing device 104 that the distance meets or exceeds the threshold distance 130. In some examples, the media manager 108 may transmit a transfer indication 134 to the computing device 104 indicating that the media session 122 is to be transferred to the mobile device 102.

In some implementations, the mobile device 102 may display a prompt 136 to the user on a display device of the mobile device 102, the prompt 136 indicating whether to accept or deny the transfer of the media session 122. For instance, in response to detecting that the distance between the mobile device 102 and the computing device 104 satisfies the threshold distance 130, the media manager 108 may cause a selectable control 138 to display on the display device of the mobile device 102, and the user may select the selectable control 138 to confirm or reject the transfer.

Similar to the mobile device 102, the computing device 104 may detect that the user is no longer in physical proximity to the computing device 104. For instance, the computing device 104 may include one or more sensors, such as a camera, a microphone, a proximity sensor, or the like, that detect that the user is no longer in front of the computing device 104. As another example, the computing device 104 may monitor sensor data received from the device sensors 110 of the mobile device 102. In some implementations, the radio devices 118 of the computing device 104 may perform the channel sounding 126 to obtain ranging data (e.g., BT ranging data, UWB ranging data) indicative of the distance between the mobile device 102 and the computing device 104. The session manager 116 may determine that the distance satisfies a threshold distance 140 and, in some cases, may transmit, to the mobile device, a distance indication 142 and/or a transfer indication 144 indicating that the distance between the computing device 104 and the mobile device 102 satisfies the threshold distance 140, and that the media session 122 is to be transferred to the mobile device 102.

The computing device 104 may transfer the media session 122 to the mobile device 102 via the communication link 128 (and/or via the communication network 106). Specifically, the computing device 104 may route an output (e.g., audio and/or video) generated by the media application 120 for the media session 122 to the mobile device 102, and the mobile device 102 may output the audio, video, or both as a transferred media session 114. The transferred media session 114 represents an input (e.g., audio and/or video) generated by the media application 120 during the media session 122, routed to the media manager 108, and output via speakers and/or a display device of the mobile device 102 (e.g., in real time). In some cases, the mobile device 102 may receive user input to the transferred media session 114 and may communicate the user input back to the computing device 104 (e.g., to the media application 120).

In implementations, the session manager 116 may select a transport method for transferring the media session 122 via the communication link 128. Some transport methods, such as physical layer (PHY) BT HDT, may be prioritized over other transport methods (e.g., Wi-Fi), for instance, due to improved throughput. The session manager 116 can determine whether a higher-priority transport method (e.g., BT HDT PHY) is available and, if so, may select it as the transport method. If the higher-priority transport method is not available, the session manager 116 can select a fallback transport method (e.g., Wi-Fi) to use for the communication link 128.

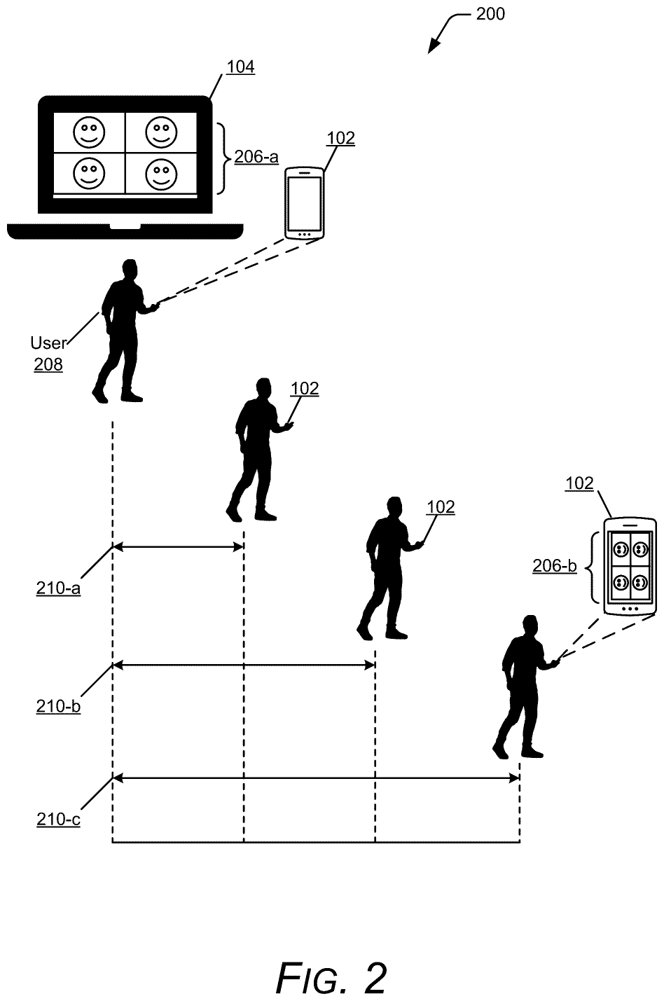

FIG. 2 illustrates an example system 200 of media session transfer for unavailable applications, as described herein. The example system 200 can be implemented in the example environment 100 and incorporates attributes of the example environment 100 introduced above. For instance, the example system 200 includes a mobile device 102 and a computing device 104 as described with reference to FIG. 1. The mobile device 102 may be an example of a portable device such as a smartphone, a tablet, a wearable device (e.g., a smartwatch, ear buds, etc.) or the like. The computing device 104 may be an example of any device with computing capabilities as described herein.

A user 202 may operate the computing device 104 and the mobile device 102. For example, the user 202 may be attending a video conference using a media application 120 running on the computing device 104, which may be stationary at a fixed location (e.g., a desk). The video conference represents a media session 122 (e.g., an active media session) of the media application 120 and may be displayed on a display of the computing device 104.

The media application 120 may be unsupported by or otherwise unavailable on the mobile device 102. As an example, access to the media session 122 may be based on a device-specific identifier (ID) that prevents any device other than the computing device 104 from accessing the media application. In another example, the media application 120 may be restricted to use with a VPN that is operable only on the computing device 104 (e.g., the mobile device 102 may not be equipped with the VPN required for access to the media application). Additionally, or alternatively, the media application 120 may not be present (e.g., may not be downloaded) on the mobile device 102, or may be configured for a different operating system than that supported by the mobile device 102.

In some cases, the mobile device 102 may support the media application 120, but may have limited capabilities (e.g., limited processing power, limited battery power) for running the media application. In yet another example, the media application 120 may be present on and supported by the mobile device 102, but the media session 122 may not be shared via the media application 120 to the mobile device 102 without significant disruption of the video conference. That is, the media application 120 may not support seamless transfer of the media session 122 between an instance of the media application on the computing device 104 and an instance of the media application on the mobile device 102. For example, the media session 122 may need to be reauthenticated on the mobile device 102, or the media application may require the user 202 to log in to the mobile device 102 and log out of the computing device 104.

At some point during the video conference, the user 202 may leave the computing device 104 to take a break, perform other tasks, etc. The user 202 may then carry the mobile device 102 while away from the computing device 104. That is, assuming that the mobile device 102 is in close physical proximity to the user 202 (e.g., in a pocket, carried by hand). Initially, the distance between the computing device 104 and the user 202 may be approximately the same as the distance between the computing device 104 and the mobile device 102. This relative distance is illustrated in FIG. 2 as relative distances 204. Thus, any discussion herein of a location or movement of the user 202, or a distance between the computing device 104 and the user 202, is representative of (e.g., equivalent to) location or movement of the mobile device 102, or a distance between the computing device 104 and the mobile device 102.

The computing device 104 and/or the mobile device 102 may detect that the user 202 (e.g., mobile device 102) is moving away from the computing device 104. For instance, the computing device 104 and/or the mobile device 102 may implement and monitor one or more sensors to detect physical and/or logical indications of movement by the user 202. The computing device 104 and/or the mobile device 102 may obtain sensor data that describes various state conditions for a physical environment in which the mobile device 102, the computing device 104, and the user 202 are positioned. The sensor data may include state information such as captured visual attributes, sound, temperature, motion, etc. The computing device 104 and/or the mobile device 102 can process the sensor data to determine whether the user 202 is in physical proximity to the computing device 104, or whether the user 202 is in motion.

The computing device 104 may, for example, monitor a proximity sensor to detect that the user 202 is no longer in proximity to the computing device 104, a motion sensor to detect that the user 202 is moving away from the computing device 104, a camera to determine that the user 202 has left the camera's frame and is no longer detectable in front of the camera, or the like. Similarly, the mobile device 102 may implement and monitor one or more sensors to detect movement of the user 202, such as a motion sensor to detect movement of the user 202 and/or movement of the mobile device 102.

In some cases, based on detecting movement of the user 202, the computing device 104 can initiate transfer of the media session 122 to the mobile device 102. The computing device 104 may transmit, to the mobile device 102, a transfer indication that the media session 122 is to be transferred to the mobile device 102. Transfer of the media session 122 may be a device-based screen projection (also referred to as screenshare, screen mirroring, or casting) with audio routing, where the computing device 104 communicates content (e.g., audio and/or video) generated by the media session 122 to the mobile device 102 for output (e.g., as a transferred media session 114. That is, the computing device 104 may utilize the display and speakers of the mobile device 102 to output the media session 122 as the transferred media session 114.

Additionally, or alternatively, the computing device 104 and the mobile device 102 may perform a channel sounding procedure to determine location and position information of the mobile device 102 and the computing device 104. Measurements obtained by channel sounding may be referred to as ranging data and can be used by the mobile device 102 and/or the computing device 104 to calculate their relative distance as the user 202 moves away from or back to the computing device 104. As illustrated, the mobile device 102 and the computing device 104 may perform channel sounding to estimate the distance 204 between the computing device 104 and the mobile device 102. Movement of the user 202 may be detected if the distance 204 changes over time.

The channel sounding procedure may be a BT channel sounding procedure, which may use phase-based ranging (PBR), round trip time (RTT), or both to accurately measure the distance (e.g., the distance 204) between two BLE-connected devices, referred to as an initiator and a reflector. The mobile device 102 and the computing device 104 may each operate as the initiator or the reflector during the channel sounding procedure. The channel sounding procedure includes a series of channel sounding events. During a channel sounding event, the initiator and the reflector alternately transmit and receive carrier wave tones used for distance estimation and data packets (e.g., cryptographically random modulated data packets) related to the channel sounding procedure. A channel sounding event includes a set of subevents, with each subevent including a set of channel sounding steps. A channel sounding step includes a sequence of coordinated carrier wave tone transmissions between the initiator and the reflector.

During a channel sounding subevent, the initiator and the reflector may each measure the RTT of the data packets and the PBR of the carrier wave tones. The RTT may be defined as the time duration a signal (e.g., one or more data packets) takes to travel from the initiator to the reflector and back again. PBR employs phase rotation in radio frequency (RF) signals, where the initiator and the reflector may each estimate a phase offset (e.g., a phase difference) between a received unmodulated signal (e.g., a carrier wave tone) and a local oscillator signal. After each channel sounding subevent, the initiator and the reflector may exchange measurement results. The channel sounding subevent may be repeated over each frequency of a set of frequencies (e.g., up to 72 frequencies, such as across a frequency band), where the RTT and the PBR measurements are obtained per frequency to account for ambiguities and provide multipath accuracy. By comparing the phase differences between the carrier wave tones from both the initiator and the reflector, and the RTTs of the data packets, the initiator and the reflector may estimate their relative distance (e.g., the distance 204).

In another example, the channel sounding procedure may be a UWB channel sounding procedure that utilizes a time of flight (ToF) measurement of a signal exchanged between the initiator and the reflector. Here, the initiator may be a UWB-enabled device and the reflector may be equipped with a UWB tag (or vice versa). The initiator and the reflector may exchange relatively high frequency (e.g., 3.12 to 10.6 GHz) impulses and may measure the ToF of each impulse. The initiator and the reflector may communicate measurement results to calculate their relative distance (e.g., the distance 204).

UWB channel sounding may be capable of estimating distances with greater accuracy than BT channel sounding. In some cases, the channel sounding procedure may employ both BT channel sounding and UWB channel sounding. Here, the initiator and the reflector may first perform BT channel sounding as a primary distance estimate, and may perform UWB channel sounding as a secondary distance estimate (e.g., to obtain a more precise distance estimate between the devices).

In implementations, the transfer of the media session 122 may be initiated once the user 202 reaches a threshold distance away from the computing device 104. The computing device 104 and the mobile device 102 may perform channel sounding and/or monitor sensor data to obtain the distance(s) 204 as the user 202 is in motion. At a first time instance, the computing device 104 and/or the mobile device 102 may first obtain a distance 204-a, which may be less than the threshold distance and thus may not trigger transfer of the media session 122. At a second time instance, the computing device 104 and/or the mobile device 102 may obtain a distance 204-b, which may also be less than the threshold distance. At a third time instance, the computing device 104 and/or the mobile device 102 may obtain the distance 204-c, which may be greater than or equal to the threshold distance.

The computing device 104 and/or the mobile device 102 can compare the distance 204-c to the threshold distance to determine that the distance 204-c satisfies (e.g., meets or exceeds) the threshold distance. Based on the comparison, the computing device 104 and/or the mobile device 102 can transmit a distance indication to signal that the distance 204-c satisfies the threshold distance. That is, if the mobile device 102 obtains the distance 204-c, the mobile device 102 can transmit the distance indication to the computing device 104. Similarly, if the computing device 104 obtains the distance 204-c, the computing device 104 can transmit the distance indication to the mobile device 102.

The transfer of the media session 122 can be initiated by the computing device 104 based on determining that the distance 204-c satisfies the threshold distance, based on receiving the distance indication from the mobile device 102, based on detecting that the user 202 is in motion, or any combination thereof. In implementations, initiating the transfer of the media session 122 may include the computing device 104 transmitting, to the mobile device 102, a transfer indication to inform the mobile device 102 of the incoming transfer. The transfer may be automatic (e.g., may be automatically performed without user input). Alternatively, the mobile device 102 may display a prompt (e.g., on a user interface or display device of the mobile device) indicating that the user 202 is to select whether to accept or deny the transfer. If the user 202 selects to accept the transfer, the transfer proceeds, but if the user 202 selects to deny the transfer, the computing device 104 will abort the transfer.

In some examples, the media session 122 may include outputs (e.g., audio and/or video generated by the media application 120) and inputs (e.g., from the computing device 104, such as a camera feed, microphone, text chat, or the like input by the user 202), and transferring the media session 122 may involve a transfer of some or all of the outputs and inputs. For instance, after the transfer is initiated, the mobile device 102 may display a prompt indicating that the user is to select audio, video, or both to be routed to the mobile device 102 (e.g., as the transferred media session 114). As another example, the transfer may be configured according to a set of functionalities. A first set of functionalities may be a maximum set of functionalities such that the transferred media session 114 includes audio and video output of the media session 122 and accepts input from the user 202 (e.g., voice chat, text chat, camera feed). A second set of functionalities may be a minimum set of functionalities such that the transferred media session 114 includes a single output, such as audio or video. Any combination of input and output may be configured as a set of functionalities according to the techniques described herein.

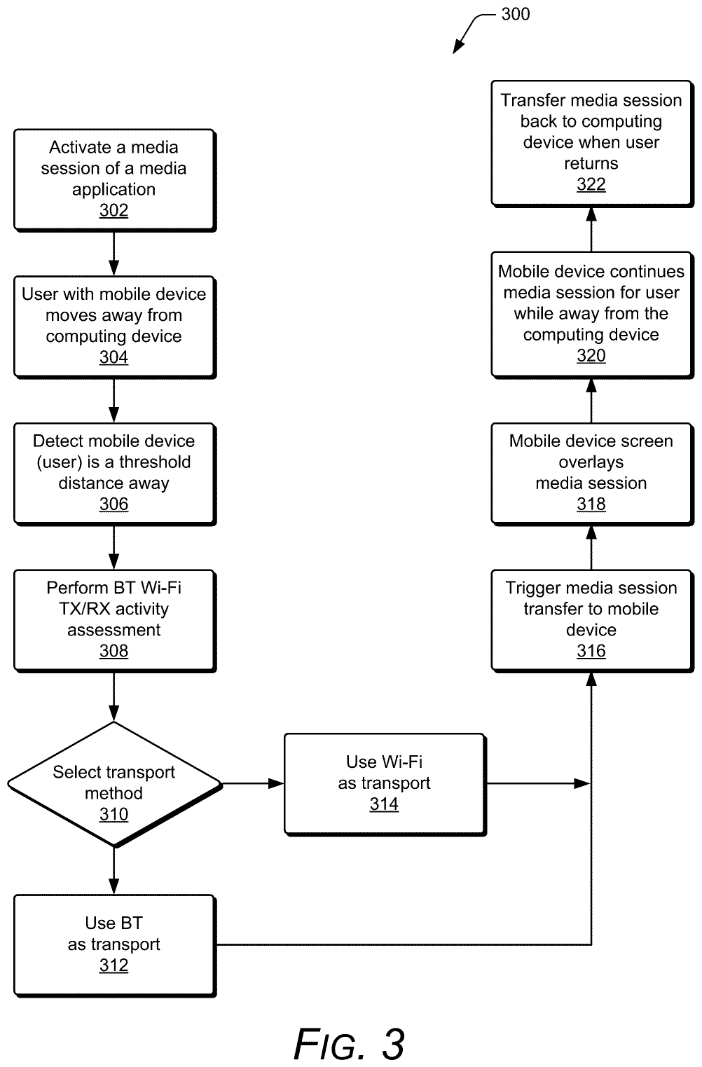

FIG. 3 illustrates an example system and procedure 300 for media session transfer for unavailable applications. The example system and procedure 300 can be implemented in the environment 100 and incorporates attributes of the environment 100 introduced above. For instance, the example system and procedure 300 includes aspects of the media manager 108 implemented by the mobile device 102 and aspects of the session manager 116 implemented by the computing device 104. A user may operate the computing device 104 and the mobile device 102 according to the example system and procedure 300.

At 302, the computing device 104 may activate a media session of a media application. For example, the media session 122 may be a video call activated within a video call application (e.g., the media application 120). At 304, the user who is carrying the mobile device 102 may move away from the computing device 104.

At 306, the mobile device 102 and/or the computing device 104 detects that the mobile device 102 (and therefore the user) is at least a threshold distance away from the computing device 104 by estimating a distance between the mobile device 102 and the computing device 104, and by determining whether the distance satisfies (e.g., meets or exceeds) the threshold distance. For instance, the mobile device 102 may collect sensor data (e.g., motion information, position or location information for the mobile device 102, position or location information for the computing device 104, etc.) from the device sensors 110. The computing device 104 may collect sensor data from the mobile device 102 or from sensors of the computing device 104. The computing device 104 and/or the mobile device 102 can estimate the distance based on the sensor data. Additionally, or alternatively, the mobile device 102 and/or the computing device 104 can perform channel sounding to estimate the distance.

At 308, the computing device 104 optionally performs a transmission reception (TX/RX) activity assessment of one or more transport methods (e.g., types of wireless communication links) for transferring the media session to the mobile device 102. In the example of FIG. 3, the TX/RX activity assessment may be a BT and Wi-Fi TX/RX activity assessment, such that the computing device 104 assesses (e.g., measures, detects) BT signal activity levels present on one or more BT channels and Wi-Fi signal activity levels present on one or more Wi-Fi channels. Additionally, or alternatively, the computing device 104 assesses signal activity levels on one or more other channels or types of channels (e.g., types of wireless communication links), such as mmWave, Zigbee, FSO, LoRa, UWB, or the like, among other examples. The computing device 104 may compare results of the TX/RX activity assessment for each type of wireless communication link.

In some cases, the computing device 104 prioritizes transport methods according to communication metrics, which can be determined by the computing device 104 based on results of the TX/RX activity assessment. For instance, the computing device 104 may prioritize the transport method having the least signal activity to avoid interference, latency, or throughput restrictions. In some cases, the computing device 104 prioritizes BT HDT as the transport method to achieve higher data throughput, e.g., compared to Wi-Fi. Alternatively, in scenarios with relatively high congestion measured by the computing device 104 on both the one or more BT channels and the one or more Wi-Fi channels, the computing device 104 can select Wi-Fi as the transport method, as Wi-Fi may support higher data rates than BT in the presence of the high congestion (e.g., high congestion may result in data rates on the order of kilobits per second (kbps) for BT, but Wi-Fi may be capable of maintaining at least 7-10 megabits per second (Mbps) in the same high congestion scenario).

At 310, the computing device 104 may select the transport method (e.g., BT, Wi-Fi, mmWave, Zigbee, FSO, LoRa, UWB, etc.) to transfer the media session to the mobile device 102. In implementations, at 310, the computing device 104 may select the transport method based on a detected media type (e.g., audio, video, or both) of the media session. For example, the computing device 104 detects whether the media session includes audio, video, or both, and selects the transport method according to the detected media type. For instance, if the media session includes video, the computing device 104 refrains from selecting BT as the transport method and instead selects Wi-Fi to transfer the media session. If the media session only includes audio (e.g., and not video), the computing device 104 can default to selecting BT as the transport method.

In implementations, the computing device 104 selects the transport method at 310 using the TX/RX activity assessment at 308. For example, the computing device 104 can perform the BT and Wi-Fi TX/RX activity assessment at 308 based on detecting that the media session includes both audio and video. Here, if the computing device 104 determines that the one or more Wi-Fi channels support a sufficient (e.g., threshold) data rate, the computing device 104 selects Wi-Fi as the transport method; if the one or more Wi-Fi channels fail to support the threshold data rate, the computing device 104 selects BT (e.g., BT HD) as the transport method. Additionally, or alternatively, the computing device 104 can utilize the results of the TX/RX activity assessment at 308 to select the transport method at 310. For instance, the computing device 104 can determine whether BT HDT is available for selection as the transport method for transferring the media session to the mobile device 102. In such examples, the computing device 104 may consider results of the TX/RX activity assessment at 308. The computing device 104 may determine that BT HDT is available if the BT and Wi-Fi TX/RX activity assessment indicates that the level of signal activity on the one or more BT HDT channels is below a threshold level of signal activity. If the BT HDT transport method is not available, the computing device 104 may select Wi-Fi as the transport method.

At 312, the computing device 104 uses BT as the transport method if the computing device 104 selects BT as the transport method at 310. Alternatively, at 314, the computing device 104 uses Wi-Fi if, at 310, the computing device 104 selects Wi-Fi as the transport method. The examples discussed herein are not to be construed as limiting and any type or combination of wireless communication links may be used as a transport method for the media session.

At 316, the computing device 104 triggers the transfer of the media session 122 to the mobile device 102. In some cases, the computing device 104 may transmit a transfer indication to the mobile device 102 indicating that the transfer is initiated. At 318, the mobile device 102 receives the transfer of the media session and a user interface display (e.g., on the display device) of the mobile device 102 may overlay the media session. At 320, the mobile device 102 continues the media session 122 (e.g., as the transferred media session 114) for the user while the user is away from the computing device 104.

At 322, the user returns to the computing device 104, and the computing device 104 triggers transfer of the media session from the mobile device 102 back to the computing device 104. For example, the computing device 104 and/or the mobile device 102 detects (e.g., based on sensor data as described with reference to 306) that the user is no longer at least the threshold distance away from the computing device 104, e.g., may detect that the user is less than the threshold distance away from the computing device 104. Based on the detecting, the computing device 104 triggers the transfer of the media session to the computing device 104. The transfer at 322 may be performed using the same transport method selected at 310. The computing device 104 may continue the media session for the user after the transfer, such that the media session is no longer routed to the mobile device 102 and the display of the mobile device 102 no longer overlays the media session.

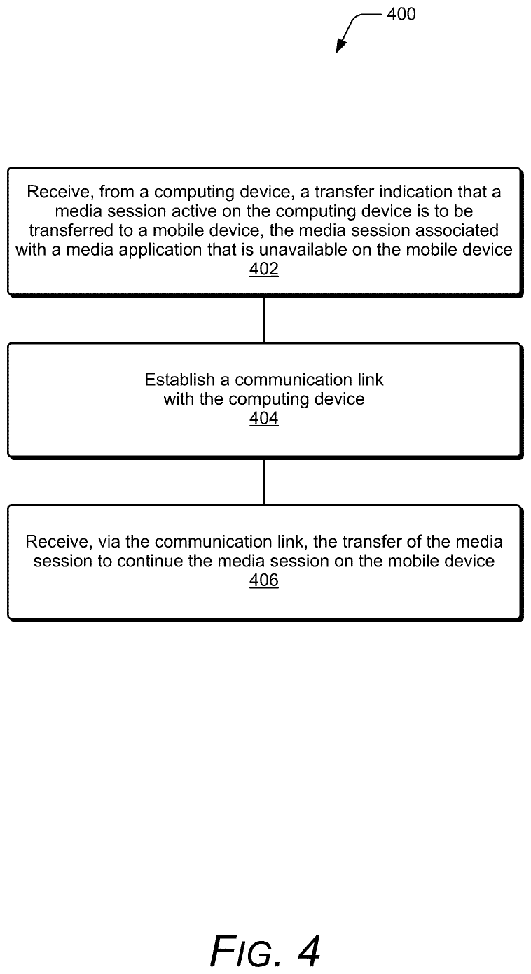

Example methods 400, 500, and 600 are described with reference to respective FIGS. 4, 5, and 6 in accordance with one or more implementations of media session transfer for unavailable applications, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method 400 for media session transfer for unavailable applications. The order in which the method is described is not intended to be construed as a limitation, and any number or combination of the described method operations may be performed in any order to perform a method, or an alternate method. Further, while the method 400 is described as being implemented by one or more components of a mobile device (e.g., the mobile device 102 as described with reference to FIG. 1), it is to be understood that any device or combination of devices may perform the techniques discussed herein.

At 402, a mobile device receives, from a computing device, a transfer indication that a media session active on the computing device is to be transferred to the mobile device. For example, the media manager 108 implemented by the mobile device 102 receives the transfer indication 134 from the computing device 104 (e.g., from the session manager 116 implemented by the computing device 104). The transfer indication 134 indicates that the media session 122 is to be transferred to the computing device 104. The media session 122 may be associated with the media application 120, which is unavailable on the mobile device 102.

At 404, a communication link is established with the computing device. For instance, an interface module of the mobile device 102 establishes the communication link 128 with an interface module of the computing device 104. The communication link 128 may include or be an example of a BT or BLE communication link, a Wi-Fi communication link, a mmW communication link, a Zigbee communication link, a LoRa communication link, an FOS communication link, or a UWB communication link, among other examples.

At 406, the transfer of the media session is received via the communication link. For example, the mobile device 102 receives audio and/or video associated with (e.g., generated or output by) the media session 122 routed from the computing device 104. The media session 122 is continued on the mobile device 102 as the transferred media session 114. For instance, the mobile device 102 outputs the routed audio and/or video via speakers and/or a display device of the mobile device 102.

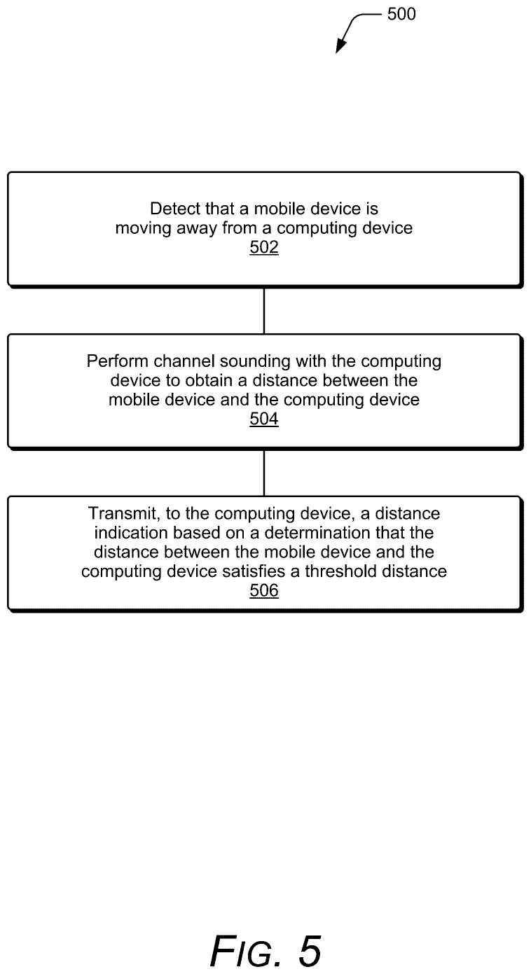

FIG. 5 illustrates example method(s) 500 for media session transfer for unavailable applications. The order in which the method is described is not intended to be construed as a limitation, and any number or combination of the described method operations may be performed in any order to perform a method, or an alternate method. Further, while the method 500 is described as being implemented by one or more components of a mobile device (e.g., the mobile device 102 as described with reference to FIG. 1), it is to be understood that any device or combination of devices may perform the techniques discussed herein.

At 502, the mobile device is detected as moving away from the computing device. For example, the device sensors 110 of the mobile device 102 collect sensor data (e.g., motion data, movement data, position data, location data, gyroscopic data, etc.) indicative of movement by the mobile device 102, and the media manager 108 implemented by the mobile device 102 receives the sensor data and determines that the mobile device 102 (e.g., and the user) is moving away from the computing device 104.

At 504, channel sounding is performed with the computing device to obtain a distance between the mobile device and the computing device. For example, the radio devices 112 of the mobile device 102 exchange RF signals (e.g., carrier wave tones, cryptographically random modulated data packets) with the radio devices 118 of the computing device 104. Based on measurements obtained from the RF signals, the computing device 104 and/or the mobile device 102 estimate the distance between the two devices.

At 506, a distance indication is transmitted to the computing device based on determining that the distance between the mobile device and the computing device satisfies a threshold distance. For instance, the media manager 108 implemented by the mobile device 102 compares the distance to the threshold distance 130 and, based on the comparing, determine that the distance meets or exceeds the threshold distance. The mobile device 102 then transmits the distance indication 132 to the computing device 104.

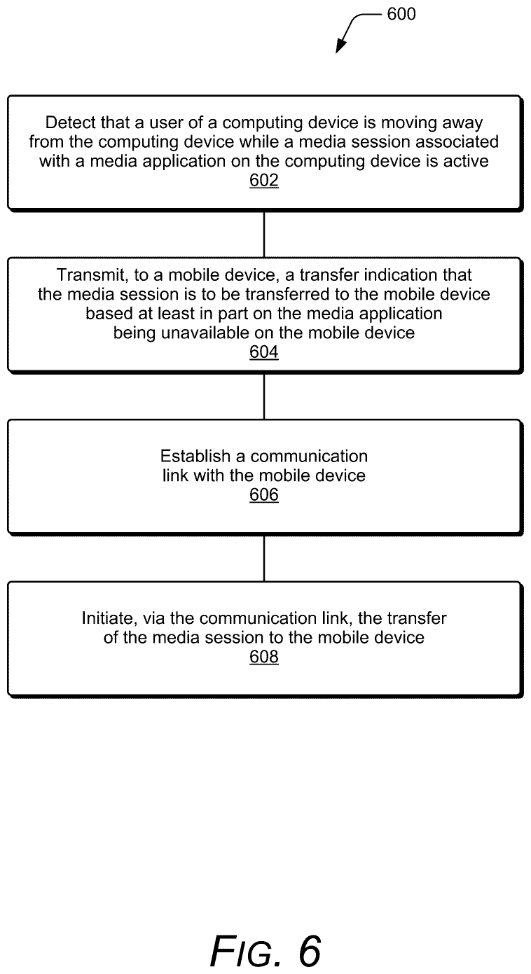

FIG. 6 illustrates example method(s) 600 for media session transfer for unavailable applications. The order in which the method is described is not intended to be construed as a limitation, and any number or combination of the described method operations may be performed in any order to perform a method, or an alternate method. Further, while the method 600 is described as being implemented by one or more components of a computing device (e.g., the computing device 104 as described with reference to FIG. 1), it is to be understood that any device or combination of devices may perform the techniques discussed herein.

At 602, a user of the computing device is detected as moving away from the computing device while a media session associated with a media application on the computing device is active. For example, the session manager 116 implemented by the computing device 104 determines (e.g., using one or more sensors, such as a camera, proximity sensor(s), motion sensor(s)) that the user is no longer in relatively close physical proximity to the computing device 104 while the media session 122 of the media application 120 is active on the computing device 104.

At 604, a transfer indication is transmitted to indicate that the media session is to be transferred to the mobile device. For example, the session manager 116 of the computing device 104 transmits the transfer indication 144 to the mobile device 102 based on the media application 120 being unavailable on the mobile device 102.

At 606, a communication link is established with the mobile device. For example, an interface module of the computing device establishes the communication link 128 with an interface module of the mobile device 102. The communication link 128 may include or be an example of a Wi-Fi communication link, a BT communication link, a UWB communication link, a mmW communication link, a Zigbee communication link, a LoRa communication link, an FOS communication link, or the like, among other examples.

At 608, the transfer of the media session to the mobile device is initiated via the communication link. For instance, the session manager 116 of the computing device 104 routes (e.g., transmits, communicates) audio, video, or both associated with (e.g., generated or output by) the media session 122 to the mobile device 102 via the communication link 128.

FIG. 7 illustrates various components of an example device 700, which can implement aspects of the techniques and features for media session transfer for unavailable applications, as described herein. The example device 700 may be implemented as any of the devices described with reference to the previous FIGS. 1-6, such as any type of a wireless device, mobile device, mobile phone, flip phone, client device, companion device, display device, tablet, computing, communication, entertainment, gaming, media playback, and/or any other type of computing and/or electronic device. For example, the mobile device 102 and/or the computing device 104 as described with reference to FIGS. 1-6 may be implemented as the example device 700.

The example device 700 can include various, different communication devices 702 that enable wired and/or wireless communication of device data 704 with other devices. The device data 704 can include any of the various device data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various different types of data input/output (I/O) interfaces 706, such as data network interfaces that provide connection and/or communication links between the devices, data networks, and other devices. The data I/O interfaces 706 may be used to couple the device to any type of components, peripherals, and/or accessory devices, such as a computer input device that may be integrated with the example device 700. The I/O interfaces 706 may also include data input ports via which any type of data, information, media content, communications, messages, and/or inputs may be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 may be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a media manager and/or session manager 718 that implements various aspects of the described features and techniques described herein. The media manager and/or session manager 718 may be implemented with hardware components and/or in software as one of the device applications 714, such as when the example device 700 is implemented as the mobile device 102 and/or the computing device 104 described with reference to FIGS. 1-6. A first example of the media manager 718 is the media manager 108 implemented by the mobile device 102, such as a software application and/or as hardware components in the mobile device 102. A second example of the session manager 718 is the session manager 116 implemented by the computing device 104, such as a software application and/or as hardware components in the computing device 104. In implementations, the media manager and/or session manager 718 may include independent processing, memory, and logic components as a computing and/or electronic device integrated with the example device 700.

The example device 700 can also include a microphone 720 (e.g., to capture an audio recording) and/or camera devices 722 (e.g., to capture images), as well as device sensors 724, such as may be implemented as components of an inertial measurement unit (IMU). The device sensors 724 may be implemented with various sensors, such as a gyroscope, an accelerometer, and/or other types of motion sensors to sense motion of the device. The device sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 726, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for media session transfer for unavailable applications have been described in language specific to features and/or methods, the appended claims are not necessarily limited to the specific features or methods described. Rather, the specific features and methods are disclosed as example implementations for media session transfer for unavailable applications, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: at least one memory; and at least one processor coupled with the at least one memory and configured to cause the mobile device to: receive, from a computing device, a transfer indication that a media session active on the computing device is to be transferred to the mobile device, the media session associated with a media application that is unavailable on the mobile device; establish a communication link with the computing device; and receive, via the communication link, the transfer of the media session to continue the media session on the mobile device.

Alternatively, or in addition to the above-described mobile device, any one or combination of: the media application is unavailable on the mobile device based at least in part on one or more of the media application being unauthenticated at the mobile device, the media application being restricted by a VPN operable only on the computing device, the media application being absent from the mobile device, or the mobile device having a limited capability for the media application. The transfer indication is received based at least in part on a determination that the mobile device is moving away from the computing device while the media session is active on the computing device. The at least one processor is configured to cause the mobile device to detect that the mobile device is moving away from the computing device; and transmit, to the computing device, a distance indication based at least in part on a determination that a distance between the mobile device and the computing device satisfies a threshold distance. To detect that the mobile device is moving away from the computing device, the at least one processor is configured to cause the mobile device to perform channel sounding with the computing device to obtain the distance between the mobile device and the computing device. To detect that the mobile device is moving away from the computing device, the at least one processor is configured to cause the mobile device to monitor sensor data of one or more sensors of the mobile device to obtain the distance between the mobile device and the computing device. The at least one processor is configured to cause the mobile device to display a prompt indicating to accept or deny the transfer of the media session to the mobile device. The at least one processor is configured to cause the mobile device to display a prompt indicating to select at least one of audio or video to be transferred as part of the media session. The communication link comprises a BT communication link, a Wi-Fi communication link, or a UWB communication link.

A method, comprising: receiving, at a mobile device from a computing device, a transfer indication that a media session active on the computing device is to be transferred to the mobile device, the media session associated with a media application that is unavailable on the mobile device; establishing a communication link with the computing device; and receiving, via the communication link, the transfer of the media session to continue the media session on the mobile device.

Alternatively, or in addition to the above-described method, any one or combination of: the media application is unavailable on the mobile device based at least in part on one or more of the media application being unauthenticated at the mobile device, the media application being restricted by a VPN operable only on the computing device, the media application being absent from the mobile device, or the mobile device having a limited capability for the media application. The transfer indication is received based at least in part on a determination that the mobile device is moving away from the computing device while the media session is active on the computing device. Detecting that the mobile device is moving away from the computing device and transmitting, to the computing device, a distance indication based at least in part on a determination that a distance between the mobile device and the computing device satisfies a threshold distance. Detecting that the mobile device is moving away from the computing device comprises performing channel sounding with the computing device to obtain the distance between the mobile device and the computing device.

A computing device, comprising: at least one memory; and at least one processor coupled with the at least one memory and configured to cause the computing device to: detect that a user of the computing device is moving away from the computing device while a media session associated with a media application on the computing device is active; transmit, to a mobile device, a transfer indication that the media session is to be transferred to the mobile device based at least in part on the media application being unavailable on the mobile device; establish a communication link with the mobile device; and initiate, via the communication link, the transfer of the media session to the mobile device.

Alternatively, or in addition to the above-described computing device, any one or combination of: to detect that the user of the computing device is moving away from the computing device, the at least one processor is configured to cause the computing device to detect that the mobile device is moving away from the computing device, and perform channel sounding with the mobile device to obtain a distance between the mobile device and the computing device, where the transfer indication is transmitted based at least in part on the distance satisfying a threshold distance. To detect that the user of the computing device is moving away from the computing device, the at least one processor is configured to cause the computing device to monitor sensor data of one or more sensors of the computing device to obtain a distance between the user and the computing device, where the transfer indication is transmitted based at least in part on the distance satisfying a threshold distance. To detect that the user of the computing device is moving away from the computing device, the at least one processor is configured to cause the computing device to receive, from the mobile device, a distance indication that a distance between the mobile device and the computing device satisfies a threshold distance. To establish the communication link with the mobile device, the at least one processor is configured to cause the computing device to select a transport method for the communication link. The communication link comprises a Bluetooth communication link, a Wi-Fi communication link, or a UWB communication link.

What is claimed is:

1. A mobile device, comprising:
at least one memory; and
at least one processor coupled with the at least one memory and configured to cause the mobile device to:
receive, from a computing device, a transfer indication that a media session active on the computing device is to be transferred to the mobile device, the media session associated with a media application that is unavailable on the mobile device;
establish a communication link with the computing device; and
receive, via the communication link, a transfer of the media session to continue the media session on the mobile device.

2. The mobile device of claim 1, wherein the media application is unavailable on the mobile device based at least in part on one or more of the media application being unauthenticated at the mobile device, the media application being restricted by a virtual private network (VPN) operable only on the computing device, the media application being absent from the mobile device, or the mobile device having a limited capability for the media application.

3. The mobile device of claim 1, wherein the transfer indication is received based at least in part on a determination that the mobile device is moving away from the computing device while the media session is active on the computing device.

4. The mobile device of claim 1, wherein the at least one processor is configured to cause the mobile device to:
detect that the mobile device is moving away from the computing device; and
transmit, to the computing device, a distance indication based at least in part on a determination that a distance between the mobile device and the computing device satisfies a threshold distance.

5. The mobile device of claim 4, wherein, to detect that the mobile device is moving away from the computing device, the at least one processor is configured to cause the mobile device to perform channel sounding with the computing device to obtain the distance between the mobile device and the computing device.

6. The mobile device of claim 4, wherein, to detect that the mobile device is moving away from the computing device, the at least one processor is configured to cause the mobile device to monitor sensor data of one or more sensors of the mobile device to obtain the distance between the mobile device and the computing device.

7. The mobile device of claim 1, wherein the at least one processor is configured to cause the mobile device to display a prompt indicating to accept or deny the transfer of the media session to the mobile device.

8. The mobile device of claim 1, wherein the at least one processor is configured to cause the mobile device to display a prompt indicating to select at least one of audio or video to be transferred as part of the media session.

9. The mobile device of claim 1, wherein the communication link comprises a Bluetooth communication link, a Wi-Fi communication link, or an ultra-wideband (UWB) communication link.

10. A computing device, comprising:
at least one memory; and
at least one processor coupled with the at least one memory and configured to cause the computing device to:
detect that a user of the computing device is moving away from the computing device while a media session associated with a media application on the computing device is active;
transmit, to a mobile device, a transfer indication that the media session is to be transferred to the mobile device based at least in part on the media application being unavailable on the mobile device;
establish a communication link with the mobile device; and
initiate, via the communication link, a transfer of the media session to the mobile device.

11. The computing device of claim 10, wherein, to detect that the user of the computing device is moving away from the computing device, the at least one processor is configured to cause the computing device to:
detect that the mobile device is moving away from the computing device; and
perform channel sounding with the mobile device to obtain a distance between the mobile device and the computing device, wherein the transfer indication is transmitted based at least in part on the distance satisfying a threshold distance.

12. The computing device of claim 10, wherein, to detect that the user of the computing device is moving away from the computing device, the at least one processor is configured to cause the computing device to monitor sensor data of one or more sensors of the computing device to obtain a distance between the user and the computing device, wherein the transfer indication is transmitted based at least in part on the distance satisfying a threshold distance.

13. The computing device of claim 10, wherein, to detect that the user of the computing device is moving away from the computing device, the at least one processor is configured to cause the computing device to receive, from the mobile device, a distance indication that a distance between the mobile device and the computing device satisfies a threshold distance.

14. The computing device of claim 10, wherein, to establish the communication link with the mobile device, the at least one processor is configured to cause the computing device to select a transport method for the communication link.

15. The computing device of claim 14, wherein the communication link comprises a Bluetooth communication link, a Wi-Fi communication link, or an ultra-wideband (UWB) communication link.

16. A method, comprising:
receiving, at a mobile device from a computing device, a transfer indication that a media session active on the computing device is to be transferred to the mobile device, the media session associated with a media application that is unavailable on the mobile device;
establishing a communication link with the computing device; and
receiving, via the communication link, a transfer of the media session to continue the media session on the mobile device.

17. The method of claim 16, wherein the media application is unavailable on the mobile device based at least in part on one or more of the media application being unauthenticated at the mobile device, the media application being restricted by a virtual private network (VPN) operable only on the computing device, the media application being absent from the mobile device, or the mobile device having a limited capability for the media application.

18. The method of claim 16, wherein the transfer indication is received based at least in part on a determination that the mobile device is moving away from the computing device while the media session is active on the computing device.

19. The method of claim 16, further comprising:
detecting that the mobile device is moving away from the computing device; and
transmitting, to the computing device, a distance indication based at least in part on a determination that a distance between the mobile device and the computing device satisfies a threshold distance.

20. The method of claim 19, wherein detecting that the mobile device is moving away from the computing device comprises performing channel sounding with the computing device to obtain the distance between the mobile device and the computing device.
